(19) United States
(12) Patent Application Publication
(10) Pub. No.: US 2025/0353394 A1
(43) Pub. Date: Nov. 20, 2025

(54) MOBILE CHARGING SYSTEM FOR ELECTRIC VEHICLES

(71) Applicant: Xos, Inc., Los Angeles, CA (US)

(72) Inventors: Ce Cheng, Baldwin Park, CA (US); Jeffrey Porcaro, Los Angeles, CA (US); Akhil Hannegudda Ganesh, Glendale, CA (US); Collin Evans, Los Angeles, CA (US); Nicole Martinez, Los Angeles, CA (US); Neil Madrid, Pasadena, CA (US)

(21) Appl. No.: 19/210,532

(22) Filed: May 16, 2025

Related U.S. Application Data
(60) Provisional application No. 63/649,283, filed on May 17, 2024.

(51) Int. Cl. B60L 53/31; B60L 53/18; B60L 53/53; B60L 53/60

(52) U.S. Cl. CPC B60L 53/31; B60L 53/18; B60L 53/53; B60L 53/60; B60L 2200/28; B60L 2210/30

(57) ABSTRACT

A mobile charging system is disclosed, comprising an energy storage module, one or more power inputs, one or more power outputs, and a system controller. The one or more power inputs are configured to receive electricity from external sources and direct it to the energy storage module or directly to the power outputs, bypassing the storage module. The one or more power outputs are configured to receive electricity from the energy storage module or from the power input and direct it to one or more charge heads. The system controller is configured to manage and control the flow of electricity between the power inputs, energy storage module, and power outputs, ensuring efficient and reliable charging of connected devices.

### CROSS-REFERENCE PARAGRAPH

This application is a U.S. Non-Provisional patent application that claims the benefit of and priority to U.S. Utility Provisional Patent Application No. 63/649,283, while was filed on May 17, 2024, entitled MOBILE CHARGING SYSTEM FOR ELECTRIC VEHICLES, the contents of which are incorporated herein by this reference as though set forth in their entirety, and to which priority is claimed.

### FIELD OF DISCLOSURE

The present disclosure relates to a mobile system for charging electric vehicles. More specifically, the present disclosure relates to a mobile system that allows for multiple power inputs and multiple power outputs, which may be deployed in locations without having to manufacture infrastructure.

### BACKGROUND

The proliferation of electric vehicles (EVs) has been significantly accelerating as a response to increasing environmental concerns and the shift towards sustainable transportation solutions. Governments and private sectors globally are investing heavily in EV technology, infrastructure, and incentives to promote the adoption of electric vehicles. Despite these advancements, one of the most prominent challenges hindering the widespread adoption of EVs remains the accessibility and convenience of charging infrastructure.

Traditional charging stations are predominantly fixed installations located at specific points such as homes, workplaces, and public parking areas. These stations, while effective, often fail to provide adequate coverage for EV users who find themselves in areas without sufficient charging facilities, or for those who are on long journeys and require flexible charging options. The fixed nature of traditional charging stations limits their accessibility and convenience, particularly in rural or underdeveloped regions where establishing charging infrastructure is economically and logistically challenging. There are also issues with respect to setting up charging infrastructure for events that are temporary in nature but might require extensive charging facilities.

To address these challenges, there is a compelling need for a more versatile and adaptable charging solution that can provide on-demand services wherever and whenever required.

### SUMMARY

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented hereinbelow. It is to be understood that both the following general description and the following detailed description are exemplary and explanatory only and are not restrictive.

It is an object of the present disclosure to provide a system that comprises energy storing structures that are capable of being charged by substantially any power source and that may dispense stored power to electric vehicles or other adjacent systems. In some embodiments, the systems may be “daisy chained” together, and at least one system may receive power from an external power source.

In some embodiments, the system may act as a hub for charging electric vehicles in locations where charging infrastructure might not exist or might be inconvenient to access.

In some embodiments, the size of the system may vary depending on the intended use. For example, systems that are intended to be placed and used without substantial movement might be larger systems, while systems intended for more frequent movement may be smaller systems.

In some embodiments, the system may use multiple energy storage structures, such as chemical or mechanical storage. In some embodiments, hydrogen may be used as the energy storage medium.

In some embodiments, the system may be configured to be hauled by a separate vehicle and may be equipped with tires and a tow hitch. In other embodiments, the system may be configured to be transported via lifting on and off a separate vehicle.

Still other advantages, embodiments, and features of the subject disclosure will become readily apparent to those of ordinary skill in the art from the following description wherein there is shown and described a preferred embodiment of the present disclosure, simply by way of illustration of one of the best modes best suited to carry out the subject disclosure. As it will be realized, the present disclosure is capable of other different embodiments and its several details are capable of modifications in various obvious embodiments all without departing from, or limiting, the scope herein. Accordingly, the drawings and descriptions will be regarded as illustrative in nature and not as restrictive.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of one embodiment of a mobile charging system for electric vehicles.

FIG. 2 is an illustration of one embodiment of a mobile charging system for electric vehicles.

FIG. 3 is a block diagram of one embodiment of a mobile charging system for electric vehicles.

### DETAILED DESCRIPTION OF THE ILLUSTRATIVE EMBODIMENTS

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware embodiments. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, electric charge storage devices or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-40% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

As used herein, the term “project owner” may refer to an individual or company, including, but not limited to, a property owner, installer, maintenance technician, contractor, device sign-in information, and/or engineer.

As used herein, the term “project type” may refer to any facet of a solar energy and/or energy storage project, including, but not limited to, installation, commissioning, inspection, maintenance and related services, warranty services, repairs and replacements, product validation, product development, training, demonstrations, sign-off, applications (use case setting, and the like), and/or fraud detection.

As used herein, the term “project goals” may refer to a goal of a solar energy and/or energy storage project, including, but not limited to, completion of the project, completion of the sign-off, impact assessment, and/or fraud detection.

As used herein, the term “project information” may include, but not be limited to: property owner information (name, address, email, phone number, site map, and the like); system design information (single line diagram (SLD), drawings, equipment list, equipment serial numbers, and the like); permit information (authority having jurisdiction (AHJ), contact persons, documentation, and the like); process information (flows for inspection, installation, commissioning, sign-off, fraud detection, training/demo, repair/replace, validation, maintenance, warranty services, product development, and the like); and/or acceptance criteria.

As used herein, the term “equipment information” may include, but not be limited to: product information (pictures, make, model, specifications, certifications, final test results, and the like); software information (versions, test results, and the like); quality information (production date, batch, alarm messages, frequent failure modules, frequent root causes, and the like); performance information (monitoring data, alarms, and the like); operations and maintenance (O&M) information (firmware update records, maintenance records, repair/replacement records, setting records, environmental records, and the like); and/or acceptance specifications (status indicators, parameters, system performance, and the like).

As used herein, the terms “impact forecast” and/or “action recommendations” may include, but not be limited to: action history; equipment performance forecast models (based on equipment information, project information, and the like); impact forecast models (on components, system performance, fraud, warranty, sign-off, usage, and the like); work instructions (install, replace, repair, commission, validate, and the like); information capture instructions (picture, video, object to capture, and the like; and/or flow instruction (such as next steps).

As used herein, the term “information capture” may include, but not be limited to, pictures, videos, texts, time stamps and GPS information, signals, documents, drawings, one or more of the project types, one or more of the project owners, one or more of the project information, action recommendations, and/or equipment information.

As used herein, the term “work actions” may include, but not be limited to, sign-in information; install, replace, repair, commission, validate, flow step, and the like.

As used herein, the term “project objects” may refer to anything related to a solar energy and/or energy storage project, including, but not limited to: photovoltaic (PV) system components (PV panel, racking, splice, end cap, roof penetration, roof clearance, sealing, flashing, cable, cable management, inter-connection, inverter, micro-inverter, optimizer, transformer, auto-transformer switch, meter, current transformer (CT), rapid shut down transmitter, rapid shut down receiver, displays screen, combiner box, circuit breaker, junction box, fuse, main panel, gateway, antenna, modem, monitoring portal display, labels, and the like); energy storage system components (battery, battery management systems (BMS), display screen, wires, critical load panel, and the like); site features (roof top, attic, rafter size, rafter span, rafter spacing, leaks, side wall, ground, trench, wiring, conduits, and the like); safety equipment (personal protective equipment (PPE), masks, gloves, face shields, arc fault face guard, signs, ladder, hand sanitizer, fall protection, and the like); and/or documentation (check list, system design, permit document, and the like).

As used herein, the term “information processing” may refer to any facet of a solar energy and/or energy storage project, including, but not limited to, image processing, text extraction, feature extraction, information classification, impact forecast refining (based on processed information, equipment information, equipment performance forecast models, impact forecast models, and the like), and/or information comparison (with acceptance criteria, project goals, and the like).

As used herein, the term “solar and energy storage projects” may refer to the construction, repair, review, and the like, of a solar energy project, an energy storage project, or both.

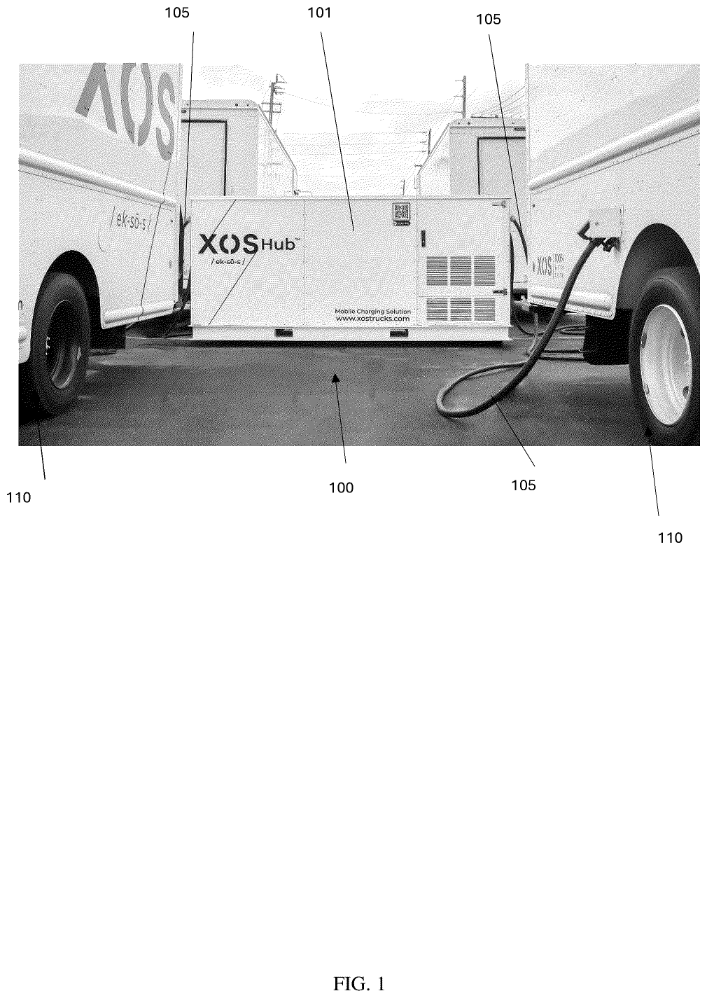

FIG. 1 is an illustration of one embodiment of a mobile charging system for electric vehicles. As shown in FIG. 1, mobile energy storage and charging system 100 of the present disclosure may include a mobile electric vehicle (EV) charging unit 101 that may have integrated energy storage that is designed to accept charge energy from both direct current (DC) and alternating current (AC) connections/sources. Some embodiments of system 100 may accept charge energy from DC or AC connections/sources. System 100 may comprise multiple EV charging cables 105 (e.g. CCS1 (North America), CCS2 (Europe), NACS (North America Charging Standard) (CCS is combined charging standard)) for simultaneous dispensing of energy to connected systems, such as vehicles 110, while providing a DC charge port connection (e.g. CCS1, CCS2, NACS) and 208/240/480V AC charge connections for intake/input of energy/power (not shown in FIG. 1). In some embodiments, a subset of the identified charge port connections may be used, or additional charge port connections may be present. Preferably, the energy provided from input sources may, optionally, directly provide power to vehicles and devices charging from the mobile EV charging unit 101 or that inputted power may provide energy to charge the on-board energy storage components of EV charging unit 101. By seamlessly integrating DC and AC charging output/charge input capabilities, mobile energy storage and charging system 100 may adapt to: (1) the specific requirements of the power grid to which system 100 is connected; (2) renewable sources of power; and (3) readily available energy source inputs. Hybrid charging technology positions mobile energy storage and charging system 100 as a robust and adaptive critical component in growing the EV charging infrastructure needed to support the growth of EV sales. Further, system 100 may contribute to a more resilient and sustainable energy ecosystem to accelerate transition to zero emissions transportation solutions.

Traditional EV charging systems may face limitations related to charging flexibility, such as relying on a specific input voltage, phase configuration, or connection type, and such as being in a permanent stationary location. The variability in available power sources may shows the need for adaptable solutions, such as system 100, to accommodate diverse charging infrastructures. Additionally, the increasing adoption of EV commercial fleets adds to the need for the development and deployment of quick reliable charge sources at various, and potentially changing, locations. System 100 addresses the demand for a versatile mobile EV charging and energy storage system capable of efficiently and seamlessly charging and being charged from both DC and AC sources.

The mobile energy storage system with integrated charging may comprise a dual charging architecture that allows the system to receive and store energy from DC connections and A/C connections. The system may include a charging interface along with intelligent circuitry that is capable of automatically detecting the input power type and voltage, and then configuring the charging and charge processes accordingly. The system may comprise multiple EV charging cables such as, but not limited to, CCS1, CCS2, NACS, for simultaneous dispensing of energy to connected systems while connected or unconnected to any input power sources. In some embodiments, the multiple charging cables may be of the same type. In other embodiments, the multiple charging cables can be various connectors and types. In other embodiments, some charging cable types may be swapped or interchanged for other charging cable types.

Energy Storage Modules. Mobile energy storage and charging system 100 may include one or more modular energy storage units or modules that are capable of storing energy (which may then be provided as electrical energy) in various forms, such as chemical, mechanical, or electrical, using various types of storage mediums. The energy storage module may interface seamlessly with a System Controller for efficient mobile energy storage and retrieval. In a preferred embodiment, the chemical storage medium may be a Lithium Ion Battery.

DC Charging Input Components. The mobile energy storage and charging system 100 may be equipped with a dedicated input port for DC connections to provide power to a main High Voltage Bus of system 100. The power provided from the DC Charging Component to the main High Voltage Bus may provide energy to charge the integrated energy storage module, or it may bypass the energy storage module to directly supply power, converted as needed, to EVs and other devices connected to system 100 for charging purposes. In a preferred embodiment, inputs for industry standard charging sources (CCS1, CCS2, CHAdeMO (Charge on de Move), NACS, MCS (Megawatt Charging System)) may be used to accept charge current and communications.

AC Charging Input Components. Mobile energy storage and charging system 100 may incorporate a separate input interface designed to receive power from AC connections/sources. The AC charging component is rectified to Direct Current (DC) (and converted if needed) and connected to the main High Voltage Bus of system 100. The power provided to the main High Voltage Bus may provide energy directly to external connected systems (EVs), or to charge the integrated Energy Storage module. In a preferred embodiment, industry standard AC connection types, such as Camlock, Powersafe®, Pin & Sleeve (IEC 60309) may be used.

DC Charging Output Components. Mobile energy storage and charging system 100 may be equipped with dedicated output ports for DC connections to provide power to externally connected systems. In a preferred embodiment, Output Connectors and Cables for industry standard charging sources (CCS1, CCS2, CHAdeMO, NACS, MCS) may be used to accept charge current and communication.

System Controller. The System Controller manages the transition, conversion, rectification, and inversion (as needed) between DC and AC charging modes, units, and modules. In some embodiments, system 100 may be configured to accept charge and/or electrical power input from both DC and AC power sources simultaneously. Additionally, the system controller may manage whether power from these inputs is routed directly to externally connected systems, or to provide charge power to the integrated energy storage module. Moreover, algorithms may be used to optimize the ever changing processes by taking into account the available power sources and the charging requirements. In a preferred embodiment, system 100 may provide user-configurable settings to allow customization of charging preferences for both input and outputs, such as, but not limited to, charging source, charging time windows, and charging rates.

Energy Storage Module: In a preferred embodiment, system 100 may integrate materials, systems, components, and functionalities used in electric vehicle (EV) battery packs and batteries for the core energy storage components. This may promote reliability and safety. In a preferred embodiment, the energy storage module may be compact and modular, which may allow flexibility in installation and high energy density. It may also be desirable to consider design considerations for ease of integration with automotive systems connectors, promoting seamless assembly with other components in electric vehicles. In some embodiments, system 100 may incorporate safety features such as thermal sensors and circuit protection mechanisms within the construction, and within the individual components.

Uses and Applications. One use of system 100 may be to store electrical energy, and leverage known technology and design principles of automotive EV battery packs. In some embodiments, system 100 may be integrated into electric vehicles, plug-in hybrid electric vehicles (PHEVs), and other automotive applications where mobile energy storage is needed or wanted. In some embodiments, the mobile energy storage module may accommodate different chemistries and capacities of EV battery packs (or other types of chemical energy storage mediums) based on cost, supply, or demand. Alternative energy storage mediums, such as Hydrogen Fuel Cell, Supercapacitor, Solid State batteries may be used. In some embodiments, efficient mobile energy storage and retrieval may be achieved through the use of an automotive EV battery pack, which is known for its high energy density and reliability. In some embodiments, seamless interfacing the system controller with other EV grade systems may optimize overall energy management. In some embodiments, leveraging scale and availability of automotive EV battery packs may be desirable. In some embodiments, leveraging the safety features inherent in automotive EV battery packs, such as thermal management systems, built-in protection circuits, and manufacturing quality, may be desirable.

Direct DC Charging Input Component. In some embodiments, high-quality conductive materials for a dedicated input port may ensure efficient energy transfer, and may be compatible with standard EV charging connectors such as CCS1, CCS2, CHAdeMO, NACS. In some embodiments, system 100 may be designed to withstand frequent and numerous connections and disconnections. In some embodiments, charging the energy storage module from direct DC sources, including EV charging stations, electric vehicle batteries, and other DC power supplies may be desirable. In some embodiments, system 100 may be suitable for various environments where direct DC EV charging is available. In some embodiments, optimal charging efficiency may be achieved through advanced rectification and voltage regulation (converter) circuits from existing EV charging infrastructure. In some embodiments, enhanced safety during the DC charging process due to overcurrent and overvoltage protection, isolation detection, and monitoring available from existing EV charging infrastructure, may be desirable.

AC Charging Input Component. System 100 may comprise standard industry AC connectors for an input interface to ensure compatibility with common AC sources, such as: Pin-and-sleeve IEC 60309, camlock, Powersafe®, etc. In some embodiments, charging from AC sources commonly found in residential, commercial, or industrial environments may be desirable. This may be beneficial when AC charging is the only source, the predominant source, the higher power source, or more readily available source. In some embodiments, safe and compatible operation may be ensured through the use of existing grid infrastructure, as desired.

Direct DC Charging Output Component. In some embodiments, high-quality conductive materials for the dedicated output ports may be used to ensure efficient energy transfer that is compatible with standard EV charging inlets such as, but not limited to, CCS1, CCS2, CHAdeMO, NACS, as desired.

Designed to Withstand Frequent Connections. In some embodiments, charging systems with standard EV charging inlets, such as CCS1, CCS2, CHAdeMO, NACS, may be desirable, such as in use for EV DCFC (direct current fast charge). In some embodiments, optimal charging efficiency may be achieved through advanced rectification and voltage regulation and/or conversion circuits from existing EV charging infrastructure. In some embodiments, compatibility with zero emissions battery electric industry charging standards may be desirable.

System Controller. In some embodiments, utilization of automotive-grade materials for the construction of the system controller, ensuring compatibility with automotive standards for environmental and physical durability, may be desirable. In some embodiments, integration of materials suitable for withstanding varying environmental conditions, including temperature fluctuations and vibrations typical in automotive environments may be desirable.

In some embodiments, management of the transition between direct DC and AC charging modes in mobile energy storage and charging system 100, specifically tailored for electric vehicles, may be desired. In some embodiments, various data processing may be conducted relating to: managing energy storage system pre-charge circuitry; charging; discharging; managing auxiliary system functionality; thermal management; fault handling; and telematics. In some embodiments, overall use data may be collected, stored, and used to determine how to best or efficiently utilize the individual systems. In some embodiments, data may be collected and processed to generate signals or communications that may be sent to a central system, which may cause other actions or notifications to be made.

In some embodiments, seamless transition between direct DC and AC charging modes may be achieved through the automotive ECU's (engine control unit) intelligent control. In some embodiments, optimization of the charging process based on the available power source and specific requirements of the energy storage medium may be desired. In some embodiments, the ability to accept both DC charge input, and AC input for charging the integrated battery system (energy storage module) or supplying power to connected systems through an EV charge cable may be desirable. In some embodiments, system 100 may comprise only a DC input, or, alternatively, only an AC input. Preferably, system 100 may have the ability to accept DC charge input while concurrently supplying power to the connected EVs/devices through the EV charge cables. This is done by disabling the isolation detection mechanisms in the integrated battery system that would normally interrupt or interfere with the connected DC input's isolation detection. In this embodiment, the DC input isolation detection system takes over and monitors the entirety of the system, such as system 100. In some embodiments, the ability to supply concurrent power to multiple connected systems while not connected to any input power source, may be desirable. In some embodiments, additional systems, devices, or modules, may supply “power boosts” from an integrated battery system while connected to an input source, such as AC connections. In some embodiments, alternative systems may be able to supply a single connected system with power at a time. Battery systems connected to EV chargers (CCS1, CCS2, NACS) are typically in a “charge mode”, which, generally, does not allow for high discharge power from the battery system. Isolation detection mechanisms in the integrated battery system would normally interrupt or interfere with the connected DC input's isolation detection, not allowing for concurrent input and output power from the system. In these systems, the battery system is the primary source of power supply to the external systems. In system 100, the battery, or energy power storage module, is only configured as one element of multiple power sources that are available to supply the Main HV (high voltage) Bus. System 100 may incorporate multiple individual isolation detection mechanisms, which allows selection of the appropriate detection methodology based on available power sources at any given time.

Allowing concurrent input and output power while connected to a DC input source resulting in new applications of expanding EV charging infrastructure. In some embodiments, system 100 may be used to expand the operational ability of a single previously installed DCFC source. In some embodiments, one charge head may be used to charge multiple concurrent systems. In some embodiments, combined with a single DC or AC input, system 100 can be “daisy chained” by plugging one of system's 100 output into one of the inputs, creating a rapidly expanding charging & energy storage network operating from a single input source. In some embodiments, system 100 may utilize multiple inputs to receive power from multiple sources simultaneously, such as from a separate system and a grid infrastructure. In some embodiments, a pass-through charging configuration may be used, such that power may bypass a first unit's battery and flow directly into a second unit, even though only the first unit may be connected to an external power source. In this embodiment, the first unit battery may be able to provide power to a power input of the second unit battery.

System 100 is configured to be updated to incorporate future DC charging input standards and/or sources. For example, CCS1 and CHAdeMO standards are slowly being superseded by the NACS standard. As the NACS standard becomes more available, the DC input interface of system 100 can easily be updated to accommodate without large architectural changes to the electrical and control systems. In some embodiments, the charging standards used in an existing system may be updated, revised, or changed to be an embodiment of system 100 or another system of mobile charging system of the present disclosure.

Depending on the needs of a customer, system 100 can be revised to include more or less internal energy storage, and more or less external output charging connections.

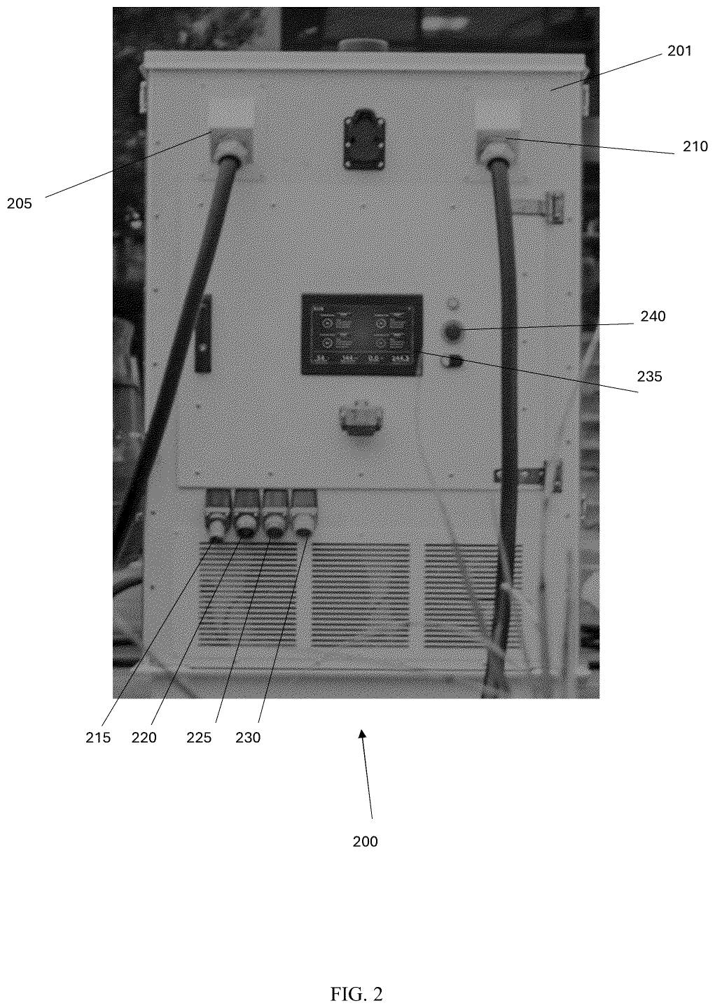

FIG. 2 is an illustration of one embodiment of a mobile energy storage and charging system for electric vehicles. As shown in FIG. 2, mobile energy storage and charging system 200 may comprise two power outputs 205, 210, four power inputs 215, 220, 225, 230, a display 235, and an emergency stop button 240. Each power output 205, 210 may be configured to engage and provide charging power to a separate EV or chargeable device. In some embodiments, power outputs 205, 210 may be the same type of connector. In other embodiments, the charge heads of power outputs 205, 210 may be different types of connectors.

Preferably, each, or at least some of the power inputs 215, 220, 225, 230 may be a different type of connection, to allow power input from a variety of sources. In some embodiments, all four power inputs 215, 220, 225, 230, or a subset thereof, may be active at the same time.

In some embodiments, there may be a plurality of additional charge heads, all of which may be the same, different, or combinations of various types of charge heads. As shown, system 100 may also comprise vented housing 201, which may be lifted onto a transport, or fitted with wheels, so as to be mobile.

Display 235, which may be duplicated via an App on a user computer or mobile device, may provide the user with: information regarding the status of outputs 205, 210 and inputs 215, 220, 225, 230; the ability to configure system 100 for maximum output and efficiency; the status of energy storage module; and the like.

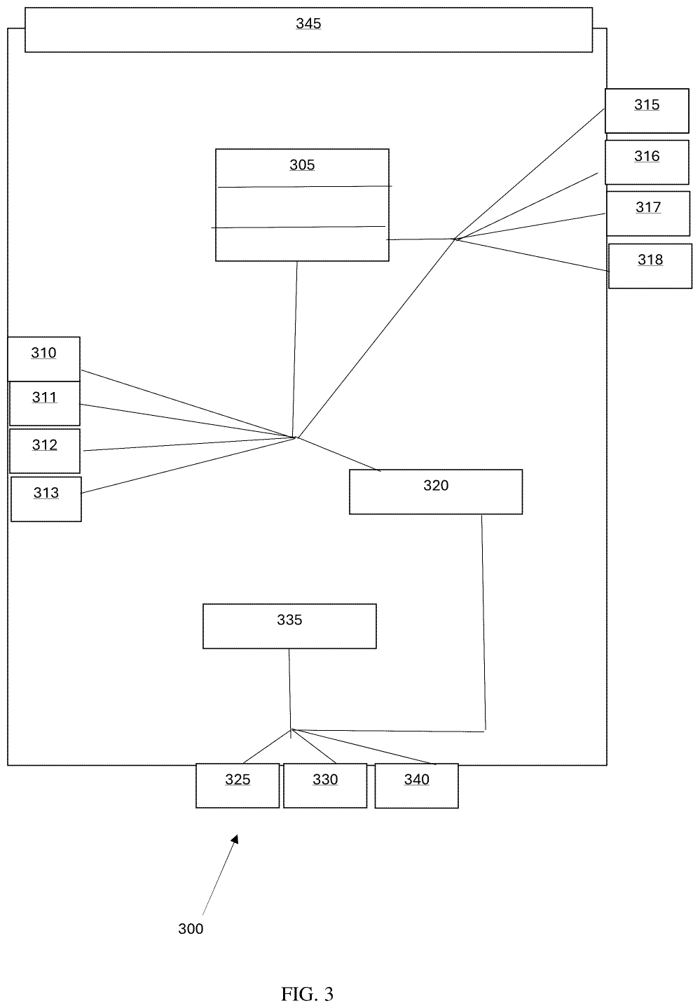

FIG. 3 is a block diagram of one embodiment of a mobile energy storage and charging system for electric vehicles. As shown in FIG. 3, the mobile energy storage and charging system 300 may comprise an energy storage module 305, one or more power inputs 310, 311, 312, 314, one or more power outputs 315, 316, 317, 318, system controller 320, emergency stop switch 325, display 330, low voltage battery 335, and wireless communication module 340.

In some embodiments, power inputs 310, 311, 312, 314 may be configured to receive power from a plurality of power sources, such as wind, solar, a power grid, an EV, another system, and/or the like. In some embodiments, power inputs 310, 311, 312, 314 may be configured to receive high voltage and high current energy. In other embodiments, power inputs 310, 311, 312, 314 may be configured to receive power from solar panels and wind turbines. In some embodiments, power inputs 310, 311, 312, 314 may be configured to receive power from other mobile charging systems, to create a mobile and modularly expandible system.

In some embodiments, low voltage battery 335 may provide power to the display 330, wireless communication module 340, and other circuitry and systems needed to run system 300.

In some embodiments, display 330 may be configured to convey information regarding the status of the mobile charging system 300, including level of charge or storage of the energy storage module 305, health of the energy storage module 305, input/output current, voltage, and wattage, various usage statistics, estimated maintenance events, and estimated repair events. In some embodiments, display 330 may also provide data regarding the quality of electricity being input or output from mobile energy storage and charging system 300.

In some embodiments, wireless communication module 340 may be configured to transmit information, data, and status updates regarding mobile energy storage and charging system 300 to a remote device, such as by cellular network, Wi-Fi, Bluetooth®, or other wireless communication protocol. Conversely, wireless communication module 340 may relay incoming commands to system 300. Some of the information, data, and status updates may comprise level of charge or storage of energy storage module 305, health of energy storage module 305, input/output current, various usage statistics, estimated maintenance events, and estimated repair events.

In some embodiments, wireless communication module 340 may also comprise wired communication ability, such that a physical device may access from mobile energy storage and charging system 300 the same information, data, and status updates described above.

In some embodiments, mobile energy storage and charging system may comprise a trailer 345. Trailer 345 may be configured to allow the system to be transported from one location to another via wheeled vehicles.

The systems and devices of the present disclosure have been presented in an illustrative style. The terminology employed throughout should be read in an exemplary rather than a limiting manner. While various exemplary embodiments have been shown and described, it should be apparent to one of ordinary skill in the art that there are many more embodiments that are within the scope of the devices and system of the present disclosure. Accordingly, the devices and systems of the present disclosure are not to be restricted, except in light of the appended claims and their equivalents.

Those of ordinary skill in the relevant art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

As used in this application, the terms “component,” “module,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers.

Various embodiments presented in terms of systems may comprise a number of components, modules, and the like. It is to be understood and appreciated that the various systems may include additional components, modules, etc. and/or may not include all of the components, modules, etc. discussed in connection with the figures. A combination of these approaches may also be used.

In addition, the various illustrative logical blocks, modules, and circuits described in connection with certain embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, system-on-a-chip, or state machine. A processor may also be implemented as a combination of computing devices, e.g., a combination of a DSP and a microprocessor, a plurality of microprocessors, one or more microprocessors in conjunction with a DSP core, or any other such configuration.

Operational embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, a DVD disk, or any other form of storage medium known in the art. An exemplary storage medium is coupled to the processor such the processor may read information from, and write information to, the storage medium. In the alternative, the storage medium may be integral to the processor. The processor and the storage medium may reside in an ASIC or may reside as discrete components in another device.

Furthermore, the one or more versions may be implemented as a method, apparatus, or article of manufacture using standard programming and/or engineering techniques to produce software, firmware, hardware, or any combination thereof to control a computer to implement the disclosed embodiments. Non-transitory computer readable media may include but are not limited to magnetic storage devices (e.g., hard disk, floppy disk, magnetic strips), optical disks (e.g., compact disk (CD), digital versatile disk (DVD)), smart cards, and flash memory devices (e.g., card, stick). Those skilled in the art will recognize many modifications that may be made to this configuration without departing from the scope of the disclosed embodiments.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those of ordinary skill in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A mobile energy storage and charging system, comprising:
an energy storage module;
one or more power inputs;
one or more power outputs; and
a system controller;
wherein said one or more power inputs are configured to receive electrical power from at least one source outside of said energy storage module and to direct said electrical power to charge said energy storage module;
wherein said one or more power outputs are configured to receive said electrical power from said energy storage module and direct said electrical power to one or more charge heads; and
wherein said system controller is configured to control a flow of said electrical power.

2. The system of claim 1, wherein said one or more power inputs comprise at least one DC charging input component.

3. The system of claim 2, wherein said at least one DC charging input component comprises a charging receiving port selected from the group of charge receiving ports consisting of: CCS1, CCS2, CHAdeMO, NACS, and MCS receiving structures.

4. The system of claim 1, wherein said one or more charge heads comprise a plug structure selected from the group of plug structures consisting of: CCS1, CCS2, CHAdeMO, NACS, and MCS plug structures.

5. The system of claim 1, wherein said one or more charge heads comprise four CCS1 plug structures.

6. The system of claim 1, wherein said energy storage module comprises one or more modular energy storage units.

7. The system of claim 1, wherein said one or more power inputs comprise an AC charging input component.

8. The system of claim 7, wherein said AC charging input component converts said electricity to a direct current.

9. The system of claim 8, wherein said direct current is sent to said energy storage module.

10. The system of claim 1, wherein said one or more power inputs comprise Camlock, Powersafe®, and Pin & Sleeve (IEC 60309).

11. The system of claim 1, further comprising a trailer configured to be towed by a vehicle.

12. A mobile charging system, comprising:
an energy storage module;
one or more power inputs;
one or more power outputs; and
a system controller;
wherein said one or more power inputs are configured to receive an electricity from outside of said energy storage module and direct said electricity to said one or more power outputs;
wherein said one or more power outputs are configured to direct said electricity to one or more charge heads; and
wherein said system controller is configured to control flow of said electricity.

13. The mobile charging system of claim 12, wherein said one or more power inputs comprise a DC charging input component.

14. The mobile charging system of claim 13, wherein said DC charging input component comprises a charging receiving port selected from the group of charge receiving ports consisting of: CCS1, CCS2, CHAdeMO, NACS, and MCS receiving structures.

15. The mobile charging system of claim 12, wherein said one or more charge heads comprise a plug structure selected from the group of plug structures consisting of: CCS1, CCS2, CHAdeMO, NACS, and MCS plug structures.

16. The mobile charging system of claim 12, wherein said one or more charge heads comprise four CCS1 plug structures.

17. The mobile charging system of claim 12, wherein said energy storage module comprises one or more modular energy storage units.

18. The mobile charging system of claim 12, wherein said one or more power inputs comprise an AC charging input component.

19. A mobile charging system, comprising:
an energy storage module;
one or more power inputs;
one or more power outputs; and
a system controller;
wherein said one or more power inputs are configured to receive an electricity from outside of said energy storage module;
wherein said one or more power inputs are configured to direct said electricity to said energy storage module and said one or more power outputs simultaneously while said energy storage module is configured to direct said electricity to said one or more power outputs, while a portion of said electricity remains in said energy storage module;
wherein said one or more power outputs are configured to direct said electricity to one or more charge heads; and
wherein said system controller is configured to control flow of said electricity.
